(19) United States
(12) Patent Application Publication
(10) Pub. No.: US 2019/0354379 A1
(43) Pub. Date: Nov. 21, 2019

(54) SYSTEM AND METHOD FOR DYNAMICALLY AND SELECTIVELY RELEASING FEATURES AND CONTENT IN AN APPLICATION CLIENT

(71) Applicant: MZ IP Holdings, LLC, Palo Alto, CA (US)

(72) Inventors: Jai Kim, San Mateo, CA (US); Gregory Heckenbach, San Jose, CA (US); Reginald Windsor Meisler, Santa Cruz, CA (US); Ajk Palikuqi, Santa Clara, CA (US)

(21) Appl. No.: 16/414,964

(22) Filed: May 17, 2019

Related U.S. Application Data
(60) Provisional application No. 62/672,662, filed on May 17, 2018.

(51) Int. Cl. G06F 9/448; H04L 29/08; H04L 12/24; G06F 16/23

(52) U.S. Cl. CPC G06F 9/4484; H04L 67/34; G06F 8/61; H04L 41/0856; G06F 16/2358; H04L 41/22

(57) ABSTRACT

A method, a system, and a computer-readable medium are provided for dynamically managing the availability of features and/or content in an application client. An example computer-implemented method can include: installing an application client on user devices of a plurality of users, wherein the application client comprises a plurality of feature modules, wherein a respective state of each feature module is either an enable state or a disable state, and wherein each feature module comprises one or more features or content that are inaccessible to the users of the application client until the respective feature module is in the enable state; and changing the state of a feature module for a subset of the plurality of users while the application client is running on the user devices.

### CROSS-REFERENCE TO RELATED APPLICATIONS

This application claims the benefit of U.S. Provisional Patent Application No. 62/672,662, filed on May 17, 2018, the entire contents of which are incorporated herein by reference.

### FIELD OF THE INVENTION

This disclosure relates to the management of applications executing on computers and, in particular, to systems and methods for dynamically managing the availability of features and/or content in an application client.

### BACKGROUND

Some computer applications provide several different features to its users. For example, an application managing a virtual world may be used to simulate real-world environments or to provide the backdrop for online games in which hundreds of thousands or even millions of players interact with each other and with the virtual environment. The virtual environment may include numerous different “elements” or “items” (also called features)—from outdoor scenes and landscapes to buildings and cityscapes to pieces of furniture, tools, or other objects, such as characters, vehicles, weapons, etc. Each of these elements may have its own parameters and characteristics, which when taken together define what the entire virtual environment looks like and how the participants interact with the elements or features in the virtual environment.

In order to effect changes in the environment, new elements/features may be introduced, some elements/features may be removed, and some elements/features may be updated or modified. Accomplishing this in an existing virtual environment can be challenging when a large number of users are interacting with the environment and with each other, and the updates must be implemented in real-time. It is desirable for such modifications to be performed in a manner that does not interrupt or compromise the users' experience within the virtual environment.

According to one solution, a re-deployment of the entire application is performed to release new code, which may provide new features and/or content in the game, web app, or an application. For example, the code on web servers may be changed when it is decided that a new feature is to be released. This can become impractical for a number of reasons.

For example, a business may need to deploy features and/or content at a moment's notice, but engineers and coordinators that can perform such a release may not be available at the time at which the release is desired. Also, the re-deployment typically incurs an overhead, from minutes to hours depending on the size of the application and how many users are using it at the time of the desired release. Consequently, the concomitant time loss must be incorporated into the redeployment plans. Moreover, if the new feature(s) are to be made available to some but not all of the users at a certain time, the new code for the application may be redeployed only to a few web-servers, so as to limit the number of users that get served the newly-released application. Such a limited re-deployment, however, does not allow for release only to a selected group of users, where the group may be defined by any property of the users, such as, for example, age, skill level, subscription level, geo-location, number of users belonging to a particular group, etc.

### SUMMARY

In various embodiments described herein, features and/or content can be included in an application client at the time of the initial deployment, but not all features/content may be accessible to one or more users or one or more groups of users (“cohorts”) at the time of the initial deployment. Rather, a “toggle” can be used that can turn certain features and/or content on and off in the application client, as desired and at any time, without requiring re-deployment of the entire application client. The present invention can, among other things, substantially reduce the network traffic associated with an application client, because the entire executable application client does not need to be repeatedly downloaded by the users for each feature and/or content change. For example, network traffic can be significantly reduced for large, massively multiplayer online (MMO) games and the like that can have hundreds of thousands or even millions of players.

To facilitate such a toggle, the application client can be implemented as a collection of several, e.g., 2, 5, 10, 30, or more, feature modules. Each feature module is configured to manage a particular set of features and/or content. As such, unless a feature module managing a particular set of features and/or content is enabled or otherwise activated when the application is executed, that particular set of features/content would not be accessible to a user.

All the feature modules that together form a complete application may be deployed at the time of the initial deployment, but some and not all of the feature modules may be enabled or activated when the execution of the application client commences. As such, the features/content that are associated with the feature modules that are not enabled or activated would not be accessible to a user. At a later time, a decision is made, either programmatically or in a data-driven manner (e.g., as determined by a designer/manager/developer of the application client), that one or more feature modules that were not activated initially are to be enabled. Upon activating those feature modules, the corresponding features/content would become available to and accessible by the users.

The decision to enable or otherwise activate a particular feature module need not be made for all the users of the application client. Rather, the decision can be made for only selected group(s)/cohort(s) of users. A “cohort” as used herein means a specific, predetermined subset of users. A decision can also be made to disable or otherwise deactivate a previously-activated feature module, so that the corresponding features/contents that were available to and accessible by one or more cohorts would no longer be available to or accessible by the users belonging to those cohorts. As such, the techniques described herein facilitate the release of any suitable number or amount of features and/or content in an application client at any time and at a moment's notice when business needs dictate such a release, and the release can be targeted to all users, any user, or a selected subset of users as the business dictates. The dynamic release and withdrawal of features and/or content can be accomplished without having to re-deploy the application client and without having to restart the application client.

Accordingly, in one aspect, a method is provided that includes installing an application client on user devices of a number of users, where the application client includes several feature modules. A respective state of each feature module is either an enable state or a disable state, and each feature module includes one or more features or content that are inaccessible to the users of the application client until the respective feature module is in the enable state. The method also includes changing the state of a feature module for a subset of the users while the application client is running on the user devices. The change is made upon an occurrence of at least one condition. After the change, the state of the feature module in the application client running on the user devices of the subset of the users is different from the state of the feature module in the application client running on the user devices of at least one user who does not belong to the subset of the users.

In some embodiments, the method includes enabling the feature module for use in the application client, when the state of the feature module changes from the disable state to the enable state; or disabling the feature module for use in the application client, when the state of the feature module changes from the enable state to the disable state. Changing the state of the feature module may include changing the state of the feature module from the disable state to the enable state. The one or more features or content that are associated with the feature module may become accessible to the subset of the users upon changing the state of the feature module to the enable state.

In some embodiments, the method includes determining whether a predetermined condition is met, and changing the state of the feature module in response to meeting the predetermined condition. In some embodiments, the method includes maintaining a database of states of at least a subset of the several feature modules. A respective state may be recorded for each feature module for each subset of the users. The method may also include changing the state of the feature module for the subset of the users when a corresponding state in the database changes. The method may include receiving, by the application client, a notification of the state of the feature module from the database, and changing the state of the feature module according to the state thereof in the received notification.

In some embodiments, the method includes transmitting, in response to a change in the database, to the application clients running on the user devices of the subset of the users, a notification of the state of the feature module. Changing the state of the feature module in the application clients running on the user devices of the subset of the users may be performed via a graphical user interface. In some embodiments, the method includes changing the state of the feature module in the application clients running on the user devices of the subset of the users to be similar to the state of the feature module in the application clients running on the user devices of one or more users who do not belong to the subset of the users.

In another aspect, a system is provided that includes one or more computer processors programmed to perform operations to install an application client on user devices of several users. The application client includes a number of feature modules, where a respective state of each feature module is either an enable state or a disable state. Each feature module includes one or more features or content that are inaccessible to the users of the application client until the respective feature module is in the enable state. The one or more computer processors are also programmed to change the state of a feature module for a subset of the users while the application client is running on the user devices, where the change is made upon an occurrence of at least one condition. After the change, the state of the feature module in the application client running on the user devices of the subset of the users is different from the state of the feature module in the application client running on the user devices of at least one user who does not belong to the subset of the users.

In some embodiments, the operations include additional operations to enable the feature module for use in the application client, when the state of the feature module changes from the disable state to the enable state; or to disable the feature module for use in the application client, when the state of the feature module changes from the enable state to the disable state. To change the state of the feature module, the one or more computer processors are further programmed to change the state of the feature module from the disable state to the enable state.

The one or more features or content that are associated with the feature module may become accessible to the subset of the users upon changing the state of the feature module to the enable state. The operations may include additional operations to determine whether a predetermined condition is met; and to change the state of the feature module in response to meeting the predetermined condition. In some embodiments, the operations include additional operations to maintain a database of states of at least a subset of the several feature modules. A respective state may be recorded for each feature module for each subset of the users. The state of the feature module for the subset of the users may be changed when a corresponding state in the database changes.

The operations may include additional operations to receive, by the application client, a notification of the state of the feature module from the database, and to change the state of the feature module according to the state thereof in the received notification. The additional operations may also include operations to transmit, in response to a change in the database, to the application clients running on the user devices of the subset of the users, a notification of the state of the feature module. In some embodiments, the operations include additional operations to change the state of the feature module in the application clients running on the user devices of the subset of the users via a graphical user interface.

In yet another aspect, a non-transitory computer-readable medium having instructions stored thereon is provided. The instructions, when executed by one or more computer processors, cause the one or more computer processors to: install an application client on user devices of a number of users, wherein the application client includes a number of feature modules. A respective state of each feature module is either an enable state or a disable state, and each feature module includes one or more features or content that are inaccessible to the users of the application client until the respective feature module is in the enable state. The instructions also cause the one or more computer processors to change the state of a feature module for a subset of the users while the application client is running on the user devices. The change is made upon an occurrence of at least one condition. After the change, the state of the feature module in the application client running on the user devices of the subset of the users is different from the state of the feature module in the application client running on the user devices of at least one user who does not belong to the subset of the users.

Elements of embodiments described with respect to a given aspect of the invention can be used in various embodiments of another aspect of the invention. For example, it is contemplated that elements of dependent claims depending from one independent claim can be used in apparatus, systems, and/or methods of any of the other independent claims

### BRIEF DESCRIPTION OF THE DRAWINGS

A more complete appreciation of the invention and many attendant advantages thereof will be readily obtained as the same becomes better understood by reference to the following detailed description when considered in connection with the accompanying drawings. In the drawings, like reference characters generally refer to the same parts throughout the different views. Further, the drawings are not necessarily to scale, with emphasis instead generally being placed upon illustrating the principles of the invention.

FIG. 1 is a schematic diagram of a system for an application managing a virtual environment, according to some embodiments;

FIG. 2 depicts an example database of states of execution units that together form an application, according to one embodiment;

FIG. 3 is a flow chart illustrating a process performed by a server for programmatically releasing features and/or content by changing the state(s) of execution unit(s), according to some embodiments;

FIG. 4 is a flow chart illustrating a process performed by a copy of a deployed application for programmatically releasing features and/or content by changing the state(s) of execution unit(s), according to some embodiments;

FIG. 5 is a flow chart illustrating a process performed by a server for releasing features and/or content by changing the state(s) of execution unit(s) using a data-driven technique, according to some embodiments; and

FIG. 6 is a flow chart illustrating a process performed by a copy of a deployed application for releasing features and/or content by changing the state(s) of execution unit(s) using the data-driven technique, according to some embodiments.

### DETAILED DESCRIPTION

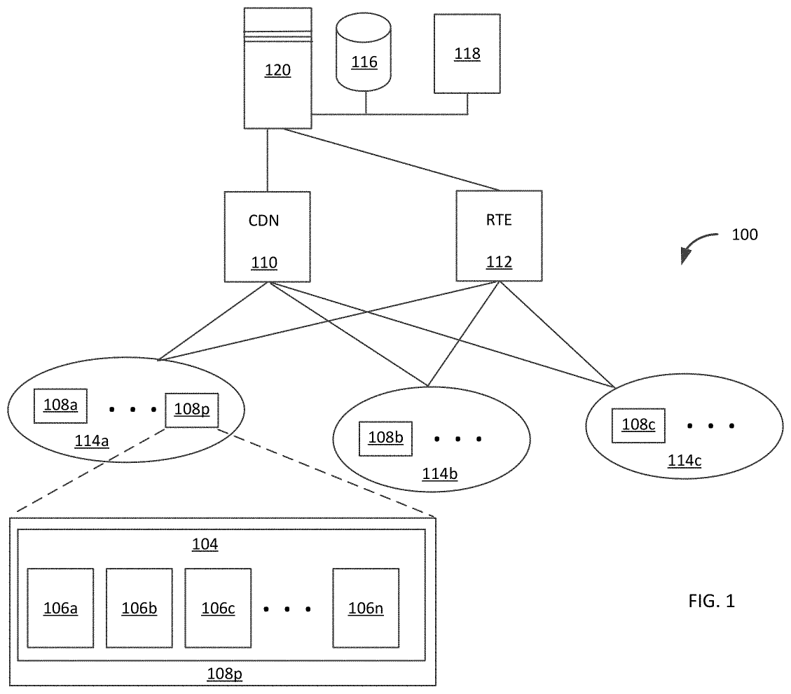

As used herein, a virtual environment can be any online environment in which users view, interact with, purchase and sell, and/or use virtual items and elements such as buildings, vehicles, virtual beings, weapons, toys, etc. In some instances, the elements of the virtual environment are used according to rules, creating a game environment in which users can compete against each other to amass items, wealth, strength, etc. With reference to FIG. 1, a system 100 includes an application client 104 (also referred to as a virtual environment application) that provides a virtual environment to various users, and allows the users to interact with the virtual environment and/or with other users. The application client 104 includes one or more feature modules 106a, 106b, . . . , 106n. The number of feature modules, in general, can be any number, such as, for example, 2, 3, 10, 18, 50, etc. Each feature module 106 may create and/or manage a particular aspect or portion of the virtual environment and the elements or features in that portion. A feature module can comprise any suitable collection of software code (e.g., in-code classes, executable code units, scripts or scripting software, and the like), data, or other information that is capable of defining, executing, or otherwise implementing features and/or content in an application client.

Users of the virtual environment may access and interact with the virtual environment from user devices 108 (e.g., a smartphone, tablet computer, laptop computer, desktop computer, and the like). A user device 108 may execute or otherwise run an application client 104. The application client 104 is deployed to one or more user devices 108, typically via a CDN (content distribution network or node(s)) 110. The deployment includes transmitting to the user devices 108 and installing thereon the application client 104, which includes one or more of the feature modules 106. In some embodiments, an RTE (real-time event) notification service 112 provides real-time or near real-time messaging capabilities among the components of the system 100. One exemplary architecture of the RTE notification service 112 is the publish-subscribe service (“PubSub”) as described in commonly-owned U.S. Pat. No. 10,270,726, issued Apr. 23, 2019, the entire disclosure of which is incorporated herein by reference.

According to an embodiment, the users of the virtual environment may be grouped into one or more cohorts. For purposes of illustration and not limitation, three cohorts 114a, 114b, 114c are shown in FIG. 1. In general, the number of cohorts can be any number, such as, for example, 1, 2, 10, 30, 100, 215, or more. The cohorts may be formed based on one or more user characteristics, such as, for example, age, geographic location, skill level, subscription level, loyalty, etc.

As described above, different feature modules 106 may create and/or manage different aspects or portions of the virtual environment and the elements or features in the respective portions. Each feature module 106 is either designated with a state of “enable” (or “activate”) or designated with a state of “disable” (or “deactivate”). In the enable state, the features (e.g., building, characters, etc.) that are managed by a particular feature module are available to and accessible by the users. For example, a user A may be able to virtually enter into a building A managed by the feature module 106a when the feature module 106a is in the enable state for that user. In the disable state, the features managed by a particular feature module are not available to or accessible by the users. Thus, the user A would not see, be able to access, nor be able to interact with the building A when the feature module 106a is in the disable state.

At the time of the initial deployment, any feature module 106 can either be in the enable state or in the disable state. According to an embodiment, at least one of the feature modules 106 can be in the enable state, however. After the initial deployment, the states of one or more feature modules can be changed one or more times and at any instance in real-time while the application client 104 is running, and without having to re-deploy and/or restart the application client 104. For example, if the feature module 106a were in the disable state at the time of deployment, denoted t0, its state could be changed to enable at time t1, where t1>t0, and could be changed back to disable at time t2, where t2>t1 Likewise, if the feature module 106c were in the enable state at time t0 (i.e., the time of deployment), its state could be changed to disable at time t3 (where t3>t0), and could be changed back to enable at time t4, where t4>t3>t0. It is not necessary that the state of each and every feature module be changed. For example, the feature module 106b may always remain in the enable state (or in the disable state).

The above-described changes of state can be carried out with respect to all users, any user, or a subset of users. For example, such state changes can be carried out in a cohort-specific manner. To illustrate using the foregoing example, at time t1, the state of the feature module 106a may be changed to enable for cohort 114b. Thus, a user B belonging to the cohort 114b would see and interact with the features corresponding to the feature module 106a (e.g., the building A). The users A and C that do not belong to cohort 114b, however, would not be able see, access, or otherwise interact with the features corresponding to the feature module 106a.

At time t4, where t2>t4>t1, the state of the feature module 106a may be changed to enable for cohort 114c. As such, users B and C, belonging to cohorts 114b and 114c, respectively, would be able to see and interact with the features corresponding to the feature module 106a. User A, who belongs to neither the cohort 114b nor the cohort 114c, would still not be able to see and interact with the features corresponding to the feature module 106a. At time t2, where t2>t4>t1, the state of the feature module 106a may be changed back to disable for cohort 114b. As such, users A and B would not be able to see and would not be able to interact with the features corresponding to the feature module 106a. User C, however, would continue to be able to see and interact with the features corresponding to the feature module 106a.

The change of state of feature modules and the corresponding release of features and/or content (or withdrawal of access to features and/or content that were previously available) can be accomplished in several ways. For example, a first technique may be referred to as the programmatic technique, and a second technique may be referred to as the data-driven technique. In the programmatic technique, one or more feature modules of the application client 104, e.g., the feature module 106b, can be configured to monitor one or more predetermined conditions. For example, the feature module 106b may determine if the number of users belonging to a particular cohort has reached a threshold limit, or if a majority of users belonging to a particular cohort has accomplished a certain task, of if the majority has failed to complete a certain task after a certain amount of time has passed, etc. Other predetermined conditions are possible. For instance, a predetermined condition could simply be a specific day or time, such as March 14th (which is known as the “pi” day) and/or at 8:05 am PST. When the feature module 106b determines that the predetermined condition has occurred, the feature module 106b would change its state. The state can change from disable to enable, but, in some cases, the state can alternatively change from enable to disable. Although the change in state could affect any users, the change in state may be limited to one or more cohorts, such that the change in state does not occur for one or more users.

When the state of a feature module (e.g., the feature module 106a) changes to enable for a particular cohort (e.g., cohort 114b), all the features and/or content associated with that feature module would become available to the users belonging to that particular cohort. In some embodiments, in its disable state the feature module 106a resides in the application client 104 on a user device (e.g., user device 108b), but is not activated or otherwise available or accessible when the user of that device is using the application client 104. When the state of the feature module 106a changes to enable, that feature module may be activated on the user device 108b and, then, the features and/or content managed by the feature module 106a would become available and accessible to the user of the user device 108b.

In other embodiments, if the state of a feature module (e.g., feature module 106a) at the time of initial deployment of application client 104 is disable, the features and/or content supported by that feature module are not available to or otherwise accessible by a user device (e.g., user device 108b). When either the application client 104 or the feature module 106a determines, as described above, that the state of the feature module 106a is to be changed to enable, the feature module 106a may be activated in the application client 104 on the user device 108b. Accordingly, the features and/or content managed by the feature module 106a would become accessible or otherwise available to the user of the user device 108b. In either of these embodiments, if the state of the feature module 106a changes from enable to disable, the feature module 106a may be deactivated from the application client 104 running on the user device 108b.

In some embodiments, the monitoring of various predetermined conditions can be performed by a server, such as a server 120 interacting as part of the system 100. When the server 120 determines that the state of a particular feature module (e.g., feature module 106c) is to be changed to enable for a particular cohort (e.g., cohort 114a), the server 120 may notify the state change to the user devices 108 of the users belonging to the cohort 114a. In some cases, the server 120 may also transmit (or instruct the CDN(s) 110 to transmit) data or other information associated with or otherwise supporting the feature module 106c to the user devices 108 of the users belonging to the cohort 114a. Upon receiving the data or other information, the application client 104 running on the respective user devices may enable the feature module 106c, as described above. Similarly, if the server 120 determines that the state of a particular feature module (e.g., feature module 106c) is to be changed to disable for a particular cohort (e.g., cohort 114c), the server 120 may notify the state change to the application clients 104 running on the user devices 108 of the users belonging to the cohort 114c. Upon receiving the notification, the respective application clients 104 may disable or otherwise deactivate the feature module 106c.

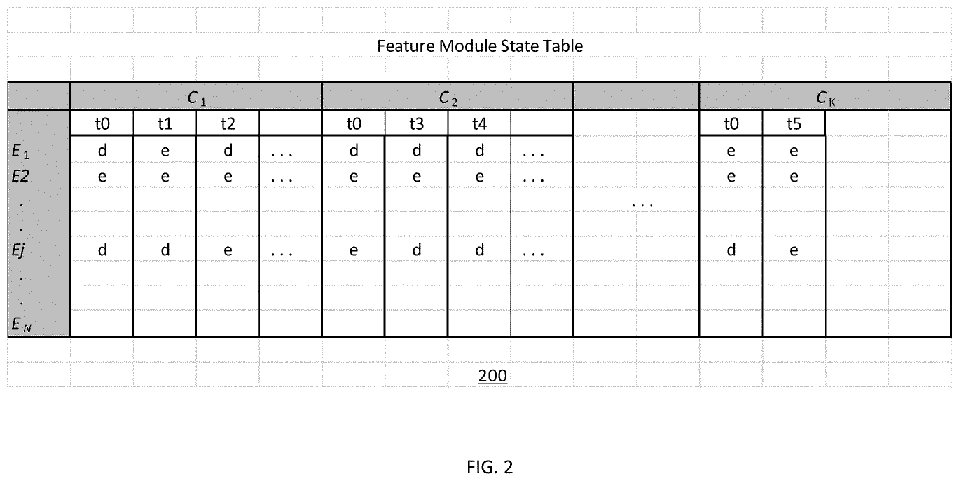

Some embodiments can employ a data-driven technique, which can offer more flexibility and control relative to the programmatic technique. In the embodiments featuring the data-driven technique, a designer, developer, or manager of the virtual environment can decide at any instance of time after the initial deployment of the application client 104 that a particular set of features/content is to be made available (or unavailable) to all users, any user, or one or more cohorts of users. Once so decided, the designer/developer/manager can update a feature module state database 116 of the system 100 via a suitable user interface 118. The designer/developer/manager can also use an appropriate web-based tool or script(s) (e.g., a scripting language such as PHP or the like) to modify the feature module state database 116. The feature module state database 116 includes for each cohort, and for each feature module that is part of the application client 104, the states of that feature module. The states of the same feature modules can be different for different cohorts, as an example database 200 shown in FIG. 2 demonstrates.

In particular, with reference to FIG. 2, an application client (which can be a virtual environment application or any other application client) includes feature modules E₁ through E_{N}. Users from K cohort groups, denoted C₁ through C_{K}, may interact with the application client and with other users. At the time of deployment, t0, the feature module E₁ is in the disable state (represented as a “d”) for cohorts C₁ and C₂, but in the enable state (represented as an “e”) for cohort C_{K}. In the present illustration, the feature module E₂ is always in the enable state for all cohorts, although it is not necessary for any feature module always to be in the enable state (or in the disable state) for all cohorts.

At time t1, where t1>t0, a designer/developer/manager can change the state of the feature module E₁ to enable for cohort C₁. The state of the feature module E₁ remains unchanged, however, for the other cohorts. Similarly, at time t3, where t3>t0, the same designer/developer/manager or another designer/developer/manager can change the state of the feature module Eⱼ to disable for cohort C₂. At time t5, where t5>t0, a designer/developer/manager can change the state of the feature module Eⱼ to enable for cohort C_{K}. There is no required ordering between the times t1, t3, and t5. At time t2, where t2>t1>t0, for cohort C₁, a designer/developer/manager can change the state of the feature module E₁ to disable, and the state of the feature module E₁ to enable. For example, the time t3 can occur before or after time t1 and/or a state change that occurs for cohort C₁ may be of no relevance to when a state change occurs for cohort C₂ or other cohorts.

Referring again to FIG. 1, when the state of a feature module changes in the feature module state database 116, a server (e.g., the server 120) may notify the state change to the application clients 104 running on the user devices 108 of the users belonging to the cohort(s) for which the state change(s) were made. In some cases, the server may also transmit (or instruct the CDN(s) 110 to transmit) the data or other information required by the feature module(s) for which the state changed to enable to support, update, or augment those features and/or content on the application clients 104 running on the user devices 108 of the users belonging to the cohort(s) for which the state change(s) were made. As described above, upon receiving the notification(s), the respective application clients 104 running on the user devices may enable the identified feature module(s) 106, or may obtain, receive, and/or load the data or other information for the identified feature module(s) 106. If for a particular cohort the state of a particular feature module changed in the feature module state database 116 to disable, the server may notify the state change to the application clients 104 running on the user devices 108 for the users belonging to that particular cohort. Upon receiving the notification, the respective application clients 104 may disable the identified feature module.

In some embodiments, the application client 104 running on a user device 108 can periodically access the feature module state database 116, and determine if the state of any feature module has changed for the cohort associated with that user device. If a state change is determined to have occurred, the application client 104 running on the user device 108 may optionally enable or otherwise activate the feature module for which the state changed to enable, or may disable or otherwise deactivate it if the state changed to disable.

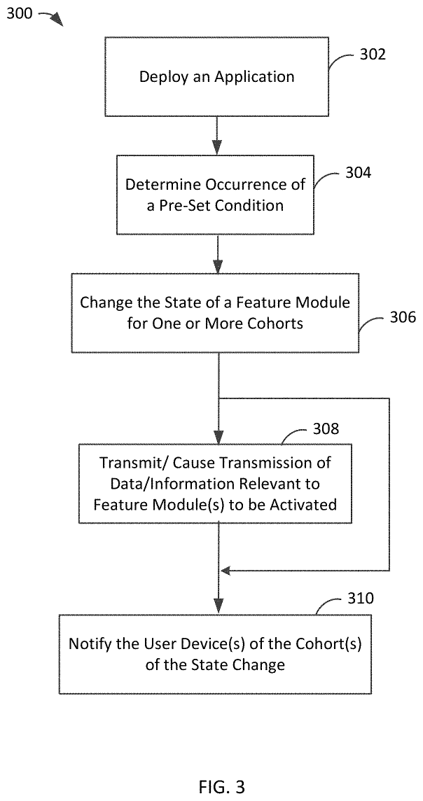

With reference to FIG. 3, the process 300 shows the operations performed by a server managing an application client, which can be any suitable application where features and/or content are to be made available to one or more groups of users in a selective manner, according to an embodiment of the programmatic technique. The application client is deployed or otherwise installed on the user devices at step 302. At step 304, the server managing the application client can determine that a predetermined condition has occurred with respect to one or more cohorts. Accordingly, at step 306, the server can change the state of one or more feature modules of the application client for one or more cohorts. Optionally, at step 308, the server can transmit (or cause to be transmitted) any data or other information necessary to support the features and/or content supported by feature module(s) for which the state changed to enable. Such data or other information is transmitted to the application clients running on the user devices of the users belonging to the cohort(s) for which the state change in the feature module(s) occurred.

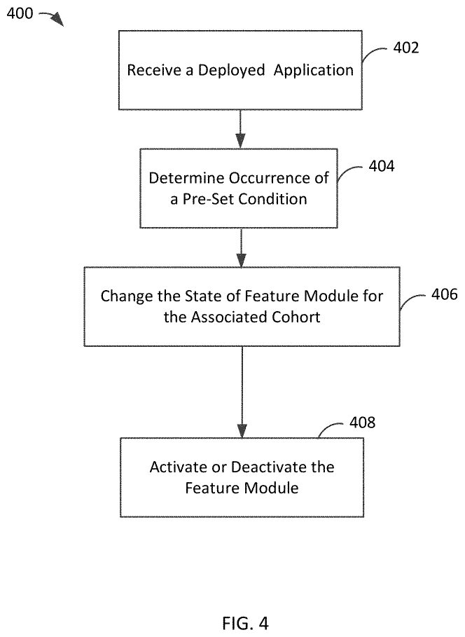

With reference to FIG. 4, the process 400 shows the operations that can be performed by the application client 104, such as that described with reference to FIG. 3, according to another embodiment of the programmatic technique, where the application client 104 is running on a user device. At step 402, a user device runs the deployed application client, which includes all of the feature modules of the application client, although only a subset of such feature modules may be enabled. The application client, while executing on the user device, determines at step 404 that a predetermined condition has occurred and, in response, changes the state of a particular feature module for the associated cohort at step 406. At step 408, if the state has changed to enable, the application client can activate that particular feature module, so that the features and/or content managed by the feature module become available or otherwise accessible to the user. At step 408, if the state has changed to disable, the application client may deactivate the feature module, so that the features and/or content managed by the feature module no longer remain accessible or otherwise available to the user.

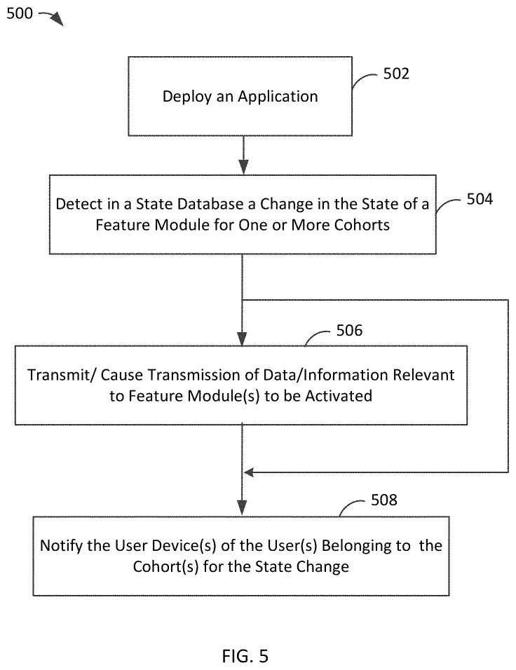

With reference to FIG. 5, the process 500 shows the operations that can be performed by a server managing an application client, such as that described with reference to FIG. 3, according to an embodiment of the data-driven technique. The application client is deployed on the user device at step 502. At step 504, the server detects that the feature module state database maintaining the states of various feature modules of the application client has changed. As discussed above, a designer/developer/manager of the application client can change entries in the feature module state database to indicate change(s) in the state(s) of one or more feature modules for one or more cohorts. Upon detecting the change, the server notifies, at step 508, the application client running on the user device(s) of the user(s) belonging to cohort(s) for whom the state change was made. Optionally at step 506, the server transmits (or causes to be transmitted) the data or other information necessary to support the features and/or content managed by feature module(s) to the application client on the user device(s) of the user(s) belonging to the respective cohort(s).

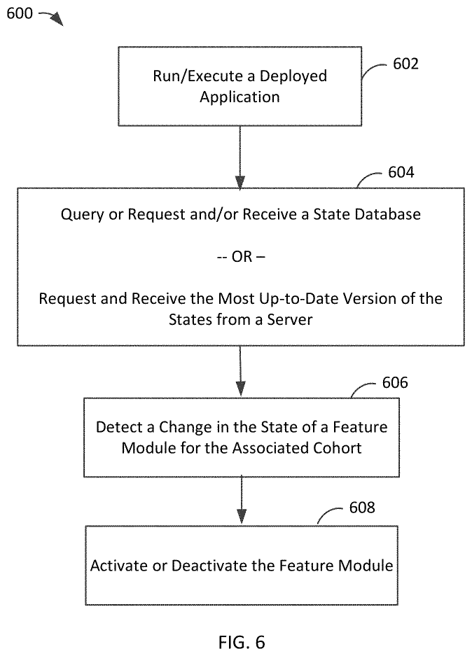

With reference to FIG. 6, the process 600 shows the operations that can be performed by the application client, such as that described with reference to FIG. 3, according to another embodiment of the data-driven technique, where the application client is installed and executed on a user device. At step 602, a user device runs the deployed application, which includes all of the feature modules of the application, although only a subset of such feature units may be enabled. At step 604, the application client, while executing on the user device, queries a feature module status database for states of the feature modules, where the feature module status database is located remotely from the application client. Alternatively, at step 604, the application client can request and receive the most up-to-date version of the states from a server (e.g., the server 120 shown in FIG. 1). At step 606, the application client can determine that the state of one or more feature modules changed for the cohort to which the user of the user device belongs. At step 608, if the state has changed to enable, the application client can activate the particular feature modules that have their states changed to enable, so that the features and/or content managed by those feature modules become available to and accessible by the user. At step 608, if the state has changed to disable, the application client may deactivate the feature module, so that the features and/or content managed by the feature module no longer remain available to or otherwise accessible by the user.

Alternatively or additionally, in some examples, the application for the game or virtual environment can be deployed on one or more servers (e.g., the server 120 shown in FIG. 1). The server application can include one or more feature modules that can be enabled or disabled for one or more cohorts according to the embodiments of the programmatic technique or the data-driven technique that are described herein.

Furthermore, in some embodiments, one or more features provided or managed by one or more feature modules may not be exposed to a user or cohort(s), regardless of whether the corresponding feature module(s) is/are enabled or otherwise activated, or disabled or otherwise deactivated. Thus, a feature, even when made available to one or more cohorts, may be invisible to those cohorts. Such a feature (referred to as the latent feature) and/or the action(s) associated therewith may be defined by a feature module referred to as the latent feature module. When the latent feature module is enabled or otherwise activated, auxiliary actions may be performed during the use of another, related feature by the user of the application client. Such other related feature may be referred to as the visible feature, and the visible feature and/or the action(s) associated therewith may be defined by a feature module referred to as the visible feature module. In some embodiments, the latent feature module may be embedded within the visible feature module. The visible feature module may be enabled or disabled for one or more cohorts. But, even when the visible feature module is enabled for certain cohort(s), the latent feature module, embedded therewithin, may not be enabled for one or more or all of those cohorts, or may be enabled for one or more, or all of those cohorts.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A method, comprising:
installing an application client on user devices of a plurality of users,
wherein the application client comprises a plurality of feature modules,
wherein a respective state of each feature module is either an enable state or a disable state, and
wherein each feature module comprises one or more features or content that are inaccessible to the users of the application client until the respective feature module is in the enable state; and
changing the state of a feature module for a subset of the plurality of users while the application client is running on the user devices,
wherein the state of the feature module in the application client running on the user devices of the subset of the plurality of users is different from the state of the feature module in the application client running on the user devices of at least one user who does not belong to the subset of the plurality of users.

2. The method of claim 1, comprising:
enabling the feature module for use in the application client, when the state of the feature module changes from the disable state to the enable state; or
disabling the feature module for use in the application client, when the state of the feature module changes from the enable state to the disable state.

3. The method of claim 1, wherein changing the state of the feature module comprises:
changing the state of the feature module from the disable state to the enable state.

4. The method of claim 1, wherein the one or more features or content that are associated with the feature module become accessible to the subset of the plurality of users upon changing the state of the feature module to the enable state.

5. The method of claim 1, comprising:
determining whether a predetermined condition is met; and
changing the state of the feature module in response to meeting the predetermined condition.

6. The method of claim 1, comprising:
maintaining a database of states of at least a subset of the plurality of feature modules,
wherein a respective state is recorded for each feature module for each subset of the plurality of users; and
changing the state of the feature module for the subset of the plurality of users when a corresponding state in the database changes.

7. The method of claim 6, comprising:
receiving, by the application client, a notification of the state of the feature module from the database; and
changing the state of the feature module according to the state thereof in the received notification.

8. The method of claim 6, comprising:
transmitting, in response to a change in the database, to the application clients running on the user devices of the subset of the plurality of users a notification of the state of the feature module.

9. The method of claim 1, comprising:
changing the state of the feature module in the application clients running on the user devices of the subset of the plurality of users via a graphical user interface.

10. The method of claim 1, comprising:
changing the state of the feature module in the application clients running on the user devices of the subset of the plurality of users to be similar to the state of the feature module in the application clients running on the user devices of the at least one user who does not belong to the subset of the plurality of users.

11. A system, comprising:
one or more computer processors programmed to perform operations to:
install an application client on user devices of a plurality of users,
wherein the application client comprises a plurality of feature modules,
wherein a respective state of each feature module is either an enable state or a disable state, and
wherein each feature module comprises one or more features or content that are inaccessible to the users of the application client until the respective feature module is in the enable state; and
change the state of a feature module for a subset of the plurality of users while the application client is running on the user devices,
wherein the state of the feature module in the application client running on the user devices of the subset of the plurality of users is different from the state of the feature module in the application client running on the user devices of at least one user who does not belong to the subset of the plurality of users.

12. The system of claim 11, wherein the operations are further to:
enable the feature module for use in the application client, when the state of the feature module changes from the disable state to the enable state; or
disable the feature module for use in the application client, when the state of the feature module changes from the enable state to the disable state.

13. The system of claim 11, wherein to change the state of the feature module the one or more computer processors are further programmed to:
change the state of the feature module from the disable state to the enable state.

14. The system of claim 11, wherein the one or more features or content that are associated with the feature module become accessible to the subset of the plurality of users upon changing the state of the feature module to the enable state.

15. The system of claim 11, wherein the operations are further to:
determine whether a predetermined condition is met; and
change the state of the feature module in response to meeting the predetermined condition.

16. The system of claim 11, wherein the operations are further to:
maintain a database of states of at least a subset of the plurality of feature modules,
wherein a respective state is recorded for each feature module for each subset of the plurality of users; and
change the state of the feature module for the subset of the plurality of users when a corresponding state in the database changes.

17. The system of claim 16, wherein the operations are further to:
receive, by the application client, a notification of the state of the feature module from the database; and
change the state of the feature module according to the state thereof in the received notification.

18. The system of claim 16, wherein the operations are further to:
transmit, in response to a change in the database, to the application clients running on the user devices of the subset of the plurality of users a notification of the state of the feature module.

19. The system of claim 11, wherein the operations are further to:
change the state of the feature module in the application clients running on the user devices of the subset of the plurality of users via a graphical user interface.

20. A non-transitory computer-readable medium having instructions stored thereon that, when executed by one or more computer processors, cause the one or more computer processors to:
install an application client on user devices of a plurality of users,
wherein the application client comprises a plurality of feature modules,
wherein a respective state of each feature module is either an enable state or a disable state, and
wherein each feature module comprises one or more features or content that are inaccessible to the users of the application client until the respective feature module is in the enable state; and
change the state of a feature module for a subset of the plurality of users while the application client is running on the user devices,
wherein the state of the feature module in the application client running on the user devices of the subset of the plurality of users is different from the state of the feature module in the application client running on the user devices of at least one user who does not belong to the subset of the plurality of users.
